(19) United States
(12) Patent Application Publication
(10) Pub. No.: US 2018/0011549 A1
(43) Pub. Date: Jan. 11, 2018

(54) CURSOR OPERATION METHOD AND DEVICE FOR INPUT METHOD

(71) Applicants: BEIJING QIHOO TECHNOLOGY COMPANY LIMITED, BEIJING (CN); QIZHI SOFTWARE (BEIJING) COMPANY LIMITED, Beijing (CN)

(72) Inventor: JUN FU, BEIJING (CN)

(73) Assignee: BEIJING QIHOO TECHNOLOGY COMPANY LIMITED, BEIJING (CN)

(21) Appl. No.: 15/541,070

(22) PCT Filed: Nov. 17, 2015
(86) PCT No.: PCT/CN2015/094842

§ 371 Date: Jun. 30, 2017

(30) Foreign Application Priority Data
Dec. 30, 2014 (CN) 201410849840.5

(51) Int. Cl. G06F 3/023; G06F 3/0488; G06F 3/01

(52) U.S. Cl. CPC G06F 3/0236; G06F 3/018; G06F 3/04883

(57) ABSTRACT

Cursor operation methods and devices for input method are disclosed. According to the method, in an interface of a common candidate word selection mode of an input method, switching to an edit string cursor slide mode or a candidate column cursor slide mode is allowed, and, after entering the edit string cursor slide mode or the candidate column cursor slide mode, switching between the two modes is allowed. In the edit string cursor slide mode, sliding of the position of the cursor in an edit string is allowed by slide operation in an input area, and operations such as editing can be performed on the edit string. In the candidate item cursor slide mode, sliding of the position of the cursor in a candidate item string is allowed by slide operation in the input area.

### CROSS-REFERENCE TO RELATED APPLICATIONS

This application is the national stage of International Application No. PCT/CN2015/094842 Nov. 17, 2015 which is based upon and claims priority to Chinese Patent Application No. CN201410849840.5, filed Dec. 30, 2014, the entire contents of all of which are incorporated herein by reference.

### TECHNICAL FIELD

The present disclosure relates to the technical field of an input method, and in particular to a cursor operation method and a cursor operation device for an input method.

### BACKGROUD

In various types of computer systems, an input language is characters in English by default. The English may be input by directly select letters. It is relatively troublesome to input other languages. For example, Chinese has tens of thousands of characters, Chinese cannot be input directly by simple keys; Chinese words need to be encoded, for example encoding the Chinese words based on a pronunciation performance of the word (corresponding to a Pinyin (Chinese phonetic transcription) input method) or encoding the Chinese word based on a font pattern of the word (such as strokes and radical) (corresponding to a font pattern input method). Various combination of keys may correspond to the encoding of a Chinese word, thereby inputting the Chinese word.

However, in an existing input method for a mobile terminal, for an edition string obtained by converting by clicking key sequences by a user, if the user needs to input a cursor in the edition string to modify the edition string, the user needs to click a certain position in the edition string. Since a display region of the edition region is narrow, the user is difficult to accurately click a desired position by clicking a touch screen, and the click operation of the user will shelter the edition string, thereby influencing accuracy of the operation of the user.

In addition, since candidate items obtained based on the edition string are displayed in a candidate bar for the input method, if the user needs to select more candidate items, the user needs to click an unfold button to unfold a candidate interface for selection. But the candidate interface will cover a keyboard of the input method, and a new candidate item cannot be displayed directly in the candidate bar by the cursor of the candidate bar.

### SUMMARY

In view of the above problems, according to the present disclosure, a cursor operation device for an input method and a corresponding cursor operation method for an input method are provided to solve the above problems or solve at least a part of the above problems.

According to an aspect of the present disclosure, a cursor operation method for an input method is provided, which includes:

monitoring whether a sliding event is received in a conventional word candidate mode of the input method;

determining a type of a preset mode condition which the sliding event meets, if the sliding event is received;

if the sliding event meets a first type of preset mode condition, entering an edition string cursor sliding mode and determining whether a continuously received sliding event in the edition string cursor sliding mode meets a first switch condition;
controlling the cursor to move in the edition string based on the continuously received sliding event if the continuously received sliding event does not meet the first switch condition;
switching the current edition string cursor sliding mode to a candidate item cursor sliding mode if the continuously received sliding event meets the first switch condition;

if the sliding event meets a second type of preset mode condition, entering the candidate item cursor sliding mode and determining whether the continuously received sliding event in the candidate cursor sliding mode meets a second switch condition;
controlling the cursor to move in a candidate item based on the continuously received sliding event if the continuously received sliding event does not meet a second switch condition; and
switching the current candidate item cursor sliding mode to the edition string cursor sliding mode if the continuously received sliding event meets the second switch condition.

According to another aspect of the present disclosure, a cursor operation device for an input method is further disclosed according to the present disclosure, which includes:

one or more processors; and

a memory;

wherein one or more programs are stored in the memory, and when executed by the one or more processors, the one or more programs cause the one or more processors to:

monitor whether a sliding event is received in a conventional word candidate mode of the input method;

determine a type of a preset mode condition which the sliding event meets, if the sliding event is received;

if the sliding event meets a first type of preset mode condition, enter an edition string cursor sliding mode and determine whether a sliding event continuously received in the edition string cursor sliding mode meets a first switch condition;
control the cursor to move in the edition string based on the continuously received sliding event if the continuously received sliding event does not meet the first switch condition; and
switch the current edition string cursor sliding mode to a candidate item cursor sliding mode if the continuously received sliding event meets the first switch condition;

if the sliding event meets a second type of preset mode condition, enter the candidate item cursor sliding mode and determine whether the sliding event continuously received in the candidate cursor sliding mode meets a second switch condition;
control the cursor to move in a candidate item based on the continuously received sliding event if the continuously received sliding event does not meet a second switch condition; and
switch the current candidate item cursor sliding mode to the edition string cursor sliding mode if the continuously received sliding event meets the second switch condition.

According to another aspect of the present disclosure, a computer program is provided, which includes computer readable code; where in a case that the computer readable codes are run on a terminal device, the terminal device is enabled to perform the cursor operation method for an input method described above.

According to another aspect of the present disclosure, a non-transitory computer readable medium is provided, which stores a computer program for performing the cursor operation method for an input method described above.

With the cursor operation method for an input method according to the present disclosure, it may be switched to an edition string cursor sliding mode or a candidate bar cursor sliding mode in an interface of the conventional word candidate mode of the input method; and when it enters the edition string cursor sliding mode or the candidate bar cursor sliding mode, switch may be performed between the two modes. In the edition string cursor sliding mode, a position of the cursor in the edition string may be changed by a sliding operation in an input region, and the edition string may be edited and so on. In the candidate item cursor sliding mode, a position of the cursor in the candidate item may be changed by a sliding operation in the input region. The following problem is solved: if the user needs to input the cursor in the edition string to modify the edition string, the user needs to click a certain position in the edition string; a display region of the edition string is narrow, the user is difficult to accurately click a desired position on a touch screen; the clicking action of the user will shelter the edition string, thereby influencing accuracy of the user operation; if the user needs to select more candidate items, the user needs to select more candidate items, the user needs to click an unfold button to unfold a candidate interface for selection; but the candidate interface will cover a keyboard of the input method, and a new candidate item cannot be displayed directly by the cursor of the candidate bar. With the method according to the present disclosure, it is convenient for the user to control the cursor for the input method to enter the edition string and move in the edition string based on the sliding operation in the input method, sight of the user is not influenced, such that the user can accurately position the cursor; it is convenient for the user to control the cursor for the input method to enter a candidate bar and move in the candidate bar based on the sliding operation in the input method, sight of the user is not influenced, and it is convenient for the user to select the candidate item.

In addition, in the present disclosure, after it enters the edition string cursor sliding mode or the candidate item cursor sliding mode, it is determined whether the received sliding event meets a mode switch condition between the edition string cursor sliding mode and the candidate item cursor sliding mode; and if the received sliding event meets the mode switch condition between the edition string cursor sliding mode and the candidate item cursor sliding mode, it is switched from the current cursor sliding mode to another cursor sliding mode. It can be switched between the edition string cursor sliding mode and the candidate item cursor sliding mode, flexibility of mode conversion is improved, and it is convenient for the user to switch the cursor sliding mode more quickly, to select the candidate item or edit the edition string.

The above illustration is only summary of technical solutions of the present disclosure. The technical means of the present disclosure can be known more clearly with reference to contents of the present disclosure. In order to make the above and other objects, features and advantages of the present disclosure become more obviously and easier to be understood, specific embodiments of the present disclosure are described hereinafter.

### BRIEF DESCRIPTION OF THE DRAWINGS

By reading the detailed description of the preferably selected embodiments below, various other advantages and benefits become clear for a person of ordinary skill in the art. The drawings are only used for showing the purpose of the preferred embodiments and are not intended to limit the present invention. And in the whole drawings, same drawing reference signs are used for representing same components. In the drawings:

FIG. 1 shows a schematic flowchart of a cursor operation method for an input method according to an embodiment of the present disclosure.

FIG. 1A shows an example of a conventional word candidate mode according to an embodiment of the present disclosure.

FIG. 1B shows an example of an edition string cursor sliding mode according to an embodiment of the present disclosure.

FIG. 1C shows an example of a candidate item cursor sliding mode obtained from FIG. 1C.

FIG. 1D shows an example of an edition string cursor sliding mode obtained from FIG. 1B.

FIG. 2 shows a schematic flowchart of a cursor operation method for an input method according to an embodiment of the present disclosure.

FIG. 3 shows a schematic structural diagram of a cursor operation device for an input method according to an embodiment of the present disclosure.

FIG. 4 shows a schematic structural diagram of a cursor operation device for an input method according to an embodiment of the present disclosure.

FIG. 5 shows a block diagram of a device for performing the method according to the present disclosure.

FIG. 6 shows a storage unit which stores or carries program codes for implementing the method according to the present disclosure.

### DETAILED DESCRIPTION

Hereinafter schematic embodiments of the present disclosure are described in detail with reference to the drawings. Although the schematic embodiments of the present disclosure are shown in the drawings, it should be understood that the present disclosure may be implemented by various manners and is not limited by the embodiments clarified here. In contrast, these embodiments are provided to make the present disclosure be understood more thoroughly and convey the scope of the present disclosure completely to those skilled in the art.

One key idea of the present disclosure is that: in a conventional word candidate mode of an input method, a triggered sliding event is received in a word candidate interface of the input method; and it is triggered to enter an edition string cursor sliding mode or a candidate item cursor sliding mode based on the sliding event. Then, after it enters the edition string cursor sliding mode or the candidate item cursor sliding mode, it is determined whether the received sliding event meets a mode switch condition between the edition string cursor sliding mode and the candidate item cursor sliding mode; and it is switched form the current cursor sliding mode to another cursor sliding mode if the switch condition is met. Therefore, according to the present disclosure, firstly, it is convenient for the user to accurately position a position of the cursor in the edition string or select candidate items displayed in the candidate bar; and secondly, it can be directly switched between the two types of cursor sliding mode, it does not need to switch to another sliding mode by another sliding event by returning the word candidate mode each time, for a certain sliding mode, such that flexibility of mode conversion is improved, and it is convenient for the user to switch the cursor sliding mode more quickly, to select the candidate item or edit the edition string.

### First Embodiment

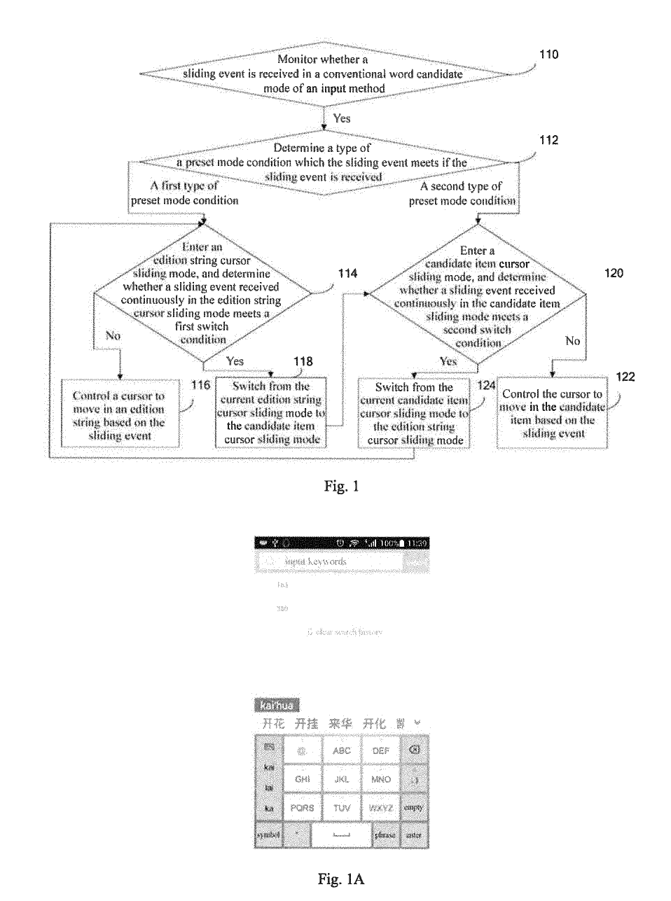

Reference is made to FIG. 1 which shows a schematic flowchart of a cursor operation method for an input method according to the present disclosure. The method includes step 110 to step 124 in the following.

In step 110, it is monitored whether a sliding event is received in a conventional word candidate mode of the input method.

In the embodiment of the present disclosure, it is assumed that a mobile terminal uses a Pinyin (Chinese phonetic transcription) input method of a nine key keyboard. For example, the nine key keyboard is as follows: key 1 corresponds to participle, key 2 corresponds to abc, key 3 corresponds to def, key 4 corresponds to ghi, key 5 corresponds to jkl, key 6 corresponds to mno, key 7 corresponds to pqrs, key 8 corresponds to tuv, and key corresponds to wxyz.

A user may click keys 524482 of the nine keys, the input method firstly identifies a key sequence 524482 based on an identification logic of the Pinyin input method, to obtain a default Pinyin string “kai′ gua”. The state based on the Pinyin string is a normal conventional word candidate mode of the input method. The conventional word candidate mode means that: the input method identifies an edition string for the key sequence obtained by clicking by the user, obtains on-screen candidate items from a lexicon based on the edition string, and displays an on-screen candidate item ranked anteriorly in a candidate bar. Taking the nine key input method as an example, FIG. 1A shows a conventional word candidate mode of the input method.

In practice, for other types of keyboard, such as an input method of a full keyboard and a conventional word candidate mode of other types of input methods, it is similar to the above example. Conventional word candidate modes of other types of input methods are also similar to the above example. For example, in a stroke input method, when the user clicks a key sequence, the input method converts the key sequence into stroke strings, obtains on-screen candidate items from a lexicon based on the stroke string and displays an on-screen candidate item ranked anteriorly in the candidate bar, in this case, it is in the conventional word candidate mode.

In the conventional word candidate mode, a sliding event of the user on a screen is received in an input keyboard region of the input method. In the embodiment of the present disclosure, the input keyboard region may be a region below the input method candidate bar, for example a region below the candidate bar where “ [symbol] ” and so on is located as shown in FIG. 1A. In practice, preferably, the input keyboard region may be selected as an input interface where 1-9 are located; or the input keyboard region may include an interface region where keys “symbol”, “ ‘ “, ” blank space” and “phrase” and the like are located.

When the user performs a sliding operation in the input keyboard region for the input method, it will trigger a sliding event. In the embodiment of the present disclosure, after the sliding event is received in the interface region for the input method, a determination will be performed for the sliding event.

In practice, in the embodiment of the present disclosure, it may be determined that a sliding event appear by a down event and a move event on a touch screen, and it may be determined that the operation of the user ends by an up event.

In step 112, a type of a preset mode condition which the sliding event meets is determined if the sliding event is received; the method enters step 114, if the sliding event meets a first type of preset mode condition; and the method enters step 120, if the sliding event meets a second type of preset mode condition.

In the present disclosure, two types of preset mode conditions may be preset: an edition string cursor sliding mode and a candidate item cursor sliding mode.

The first type of preset mode condition may include that: with reference to a vertical direction and a horizontal direction of a touch screen (as shown in FIG. 1A), an end point for the sliding event is on the left side of a starting point for the sliding event (corresponding to top and bottom in the vertical direction and left and right in the horizontal direction as shown in FIG. 1A); an angle between a sliding direction and the horizontal direction is less than a threshold, such as 60 degrees; and a distance from the sliding starting point to the sliding end point in the horizontal direction reaches a threshold, such as 3 (left and right direction shown in FIG. 1A). If the sliding event meets the above conditions, it is determined that the sliding event meets the first type of preset mode condition.

The second type of preset mode condition may include that: with reference to the vertical direction and the horizontal direction of the touch screen (as shown in FIG. 1A), the end point for the sliding event is on the right side of the starting point for the sliding event; the angle between the sliding direction and the horizontal direction is less than a threshold, such as 60 degrees; the distance from the sliding starting point to the sliding end point in the horizontal direction reaches a threshold, such as 3. If the sliding event meets the above conditions, it is determined that the sliding event meets the second type of preset mode condition.

If initial focus coordinates are (10, 10) when a user presses the touch screen and coordinates of the touched focus change as the user slides, for example to coordinates (7, 10), the focus coordinates after sliding are on the left of the initial focus coordinates, the sliding event is sliding towards left, an angle between a sliding direction and the horizontal direction is 0, and a sliding distance in the horizontal direction is 3 that reaches the above threshold. Therefore it is determined that the sliding event meets the first type of preset mode condition.

If initial focus coordinates are (7, 5) when a user presses the touch screen and coordinates of the touched focus change as the user slides, for example to coordinates (10, 5), the focus coordinates after sliding are on the right of the initial focus coordinates, the sliding event is sliding towards right, an angle between a sliding direction and the horizontal direction is 0, and a sliding distance in the horizontal direction is 3 that reaches the above threshold. Therefore it is determined that the sliding event meets the second type of preset mode condition.

The angle between the sliding direction and the horizontal direction may be calculated by an inverse trigonometric function such as an arccos function. It is assumed that coordinates of a starting point is (x1, y1), coordinates of an end point is (x2, y2), an angle between a sliding direction and a horizontal direction is A, therefore a vector between the coordinates (x1, y1) and an origin point is (x1, y1), a vector between the coordinates (x1, y1) and the original point is (x2, y2), and

$$A = arcos ( \frac{\vert {x}_{1} {x}_{2} + {y}_{1} {y}_{2} \vert}{\sqrt{{x}_{1}^{2} + {y}_{1}^{2}} \times \sqrt{{x}_{2}^{2} + {y}_{2}^{2}}} ) .$$

In this way, the angle between the sliding direction of the user on the touch screen and the horizontal direction may be obtained.

Preferably, the determining the type of the preset mode condition which the sliding event meets may include substep 1121 and substep 1122.

In substep 1121, it is determined that the sliding event meets the first type of preset mode condition when the sliding event is a sliding operation towards a head of an edition string in a keyboard region for the input method.

In the embodiment of the present disclosure, it is determined whether the sliding event is the sliding operation towards the head of the edition string in the keyboard region of the input method as follows. With reference to the vertical direction and the horizontal direction of the touch screen (as shown in FIG. 1A), an end point for the sliding event is on the left of a starting point for the sliding event, i.e., the sliding is towards a head of the edition string, a distance threshold from the sliding starting point to the sliding end point in the horizontal direction is x and an angle between the sliding direction and the horizontal direction is less than a threshold y, it is determined that the sliding event meets the first type of preset mode condition.

In substep 1122, it is determined that the sliding event meets a second type of preset mode condition when the sliding event is a sliding operation towards an end of a candidate item in the keyboard region for the input method.

In the embodiment of the present disclosure, it is determined whether the sliding event is the sliding operation towards the end of the edition string in the keyboard region of the input method as follows. With reference to the vertical direction and the horizontal direction of the touch screen (as shown in FIG. 1A), an end point for the sliding event is on the right of a starting point for the sliding event, i.e., sliding towards an end of the edition string, a distance threshold from the sliding starting point to the sliding end point in the horizontal direction is x and an angle between the sliding direction and the horizontal direction is less than a threshold y, it is determined that the sliding event meets the first type of preset mode condition.

In addition, two types of switch condition are further preset in the present disclosure. It is determined to switch from a current edition string cursor sliding mode to a candidate item cursor sliding mode based on a first switch condition and it is determined to switch from a current candidate item cursor sliding mode to the edition string cursor sliding mode based on a second switch condition.

The first switch condition includes that: with reference to the vertical direction and the horizontal direction of the touch screen (as shown in FIG. 1A), the end point for the sliding event is on a lower side of the starting point for the sliding event (corresponding to upper and lower in the vertical direction and left and right in a corresponding horizontal direction as shown in FIG. 1A); the angle between the sliding direction and the vertical direction is less than a threshold, such as 30 degrees; and a distance from the sliding starting point to the sliding end point in the vertical direction reaches a threshold, for example 3 (left and right direction in FIG. 1). If the sliding event meets the above conditions, it is determined that the sliding event meets the first switch condition.

The second switch condition may include that: with reference to the vertical direction and the horizontal direction of the touch screen (as shown in FIG. 1A), the end point for the sliding event is on a upper side of the starting point for the sliding event (corresponding to upper and lower in the vertical direction and left and right in the horizontal direction as shown in FIG. 1A); the angle between the sliding direction and the vertical direction is less than a threshold, such as 30 degrees; and a distance from the sliding starting point to the sliding end point in the vertical direction reaches a threshold, such as 3. If the sliding event meets the above conditions, it is determined that the sliding event meets the second switch condition.

If initial focus coordinates are (10, 10) when a user presses the touch screen and coordinates of the touched focus change as the user slides, for example to coordinates (10, 7), the focus coordinates after sliding are on the lower side of the initial focus coordinates, the sliding event is sliding towards downward, an angle between a sliding direction and the vertical direction is 0, and a sliding distance in the horizontal direction is 3 that reaches the above threshold, therefore it is determined that the sliding event meets the first switch condition.

If initial focus coordinates are (7, 5) when a user presses the touch screen and coordinates of the touched focus change as the user slides, for example to coordinates (7, 8), the focus coordinates after sliding are on the upper side of the initial focus coordinates, the sliding event is sliding towards upward, an angle between a sliding direction and the horizontal direction is 0, and a sliding distance in the horizontal direction is 3 that reaches the above threshold, therefore it is determined that the sliding event meets the second switch condition.

In practice, an angle B between the sliding direction and the vertical direction may be calculated by a similar arccos function described above. In the embodiment of the present disclosure, after the angle A between the sliding direction and the horizontal direction is calculated, the angle between the sliding direction and the vertical direction may be obtained by 90-A.

In practice, in the embodiment, the angle may be calculated by any method, in addition to the arccos function.

In the embodiment, as described above, it may be identified whether the sliding event meets which type of preset mode condition or does not meet any type of preset mode condition, according to coordinate positions and relative positions and distances between coordinates for the up event, down event and move event.

In the embodiment, the first switch condition includes sliding downward in a case that an angle between the sliding direction and the vertical direction is less than a threshold; and the second switch condition includes sliding upward in a case that the angle between the sliding direction and the vertical direction is less than the threshold.

In the embodiment of the present disclosure, in a conventional word candidate mode of the input method, firstly it is determined whether the sliding event meets a type of a preset mode condition, and it is not determined whether the sliding event meets the first switch condition or the second switch condition.

In the conventional word candidate mode of the input method, the method enters an edition string cursor sliding mode if the sliding event meets a first type of preset mode condition. Then it is switched from the current conventional word candidate mode to an edition string cursor sliding mode, as shown in FIG. 1B, and then a cursor is controlled to move in an edition string based on the sliding event. If the sliding event meets a second type of preset mode condition, the method enters a candidate item cursor sliding mode, as shown in FIG. 1C, and then the cursor is controlled to move in a candidate item based on the sliding event.

As described in the above example, if initial focus coordinates are (10, 10) when a user presses the touch screen and coordinates of the touched focus change as the user slides, for example to coordinates (10, 7), the focus coordinates after sliding are on the lower side of the initial focus coordinates, the sliding event is sliding towards downward, an angle between a sliding direction and the vertical direction is 0, and a sliding distance in the horizontal direction is 3 that reaches the above threshold 3, therefore it is determined that the sliding event meets the first switch condition, and it enters the edition string cursor sliding mode.

If initial focus coordinates are (7, 5) when a user presses the touch screen and coordinates of the touched focus change as the user slides, for example to coordinates (10, 5), the focus coordinates after sliding are on the left side of the initial focus coordinates, the sliding event is sliding towards left, an angle between a sliding direction and the vertical direction is 0, and a sliding distance in the horizontal direction is 3 that reaches the above threshold 3, therefore it is determined that the sliding event meets the second switch condition, and the method enters the candidate item cursor sliding mode.

Preferably, the entering an edition string cursor sliding mode if the sliding event meets the first type of preset mode condition, and determining whether the sliding event continuously received in the edition string cursor sliding mode meets the first switch condition may include substep 1123 to substep 1125.

In substep 1123, a first state identification of the current conventional word candidate mode is changed into a second state identification of the edition string cursor sliding mode, if the sliding event meets the first type of preset mode condition.

In substep 1124, when a sliding event is received continuously, it is determined whether the state identification of the input method is the second state identification.

In subset 1125, if the current state identification of the input method is the second state identification, it is determined whether the sliding event received continuously in the edition string cursor sliding mode meets the first switch condition.

In the embodiment of the present disclosure, in order to ensure that it is not determined for each sliding whether the preset mode condition described above is met and it is not triggered an operation to enter a cursor sliding mode each time, the first state identification of the conventional word candidate mode and the second state identification of the edition string cursor sliding mode are maintained in the present disclosure. In a specific mode, a corresponding state identification is used. As described above, for the input method, an edition string is identified based on a key sequence obtained by clicking by a user, on-screen candidate items are obtained from a lexicon based on the edition string, and on-screen candidate items ranked anteriorly are displayed in a candidate bar, that is, this is the conventional word candidate mode, in this case the first state identification is used; then when the method enters the edition string cursor sliding mode, the first state identification of the current conventional word candidate mode is changed into the second state identification of the edition string cursor sliding mode.

When a sliding event is received continuously, it is determined a type of the current state identification of the input method; if the determined type is a first state identification, it is determined whether a sliding event received continuously in the edition string cursor sliding mode meets the first switch condition.

Preferably, the entering a candidate item sliding mode if the sliding event meets a second type of preset mode condition, and determining whether a sliding event received continuously in the candidate item cursor sliding mode meets a second switch condition may include substep 1126 to substep 1128.

In substep 1126, a first state identification of the current conventional word candidate mode is changed into a third state identification of the candidate item cursor sliding mode, if the sliding event meets the second type of preset mode condition.

In substep 1127, it is determined whether a state identification of the input method is a third state identification, when a sliding event is received continuously.

In substep 1128, if the current state identification of the input method is the third state identification, it is determined whether a sliding event received continuously in the candidate item cursor sliding mode meets the second switch condition.

In the embodiment of the present disclosure, in order to ensure that it is not determined for each sliding whether the preset mode condition described above is met and it is not triggered an operation to determine a cursor sliding mode each time, the first state identification of the conventional word candidate mode and the third state identification of the candidate item cursor sliding mode are maintained in the present disclosure. In a specific mode, a corresponding state identification is used. As described above, for the input method, an edition string is identified based on a key sequence obtained by clicking by a user, on-screen candidate items are obtained from a lexicon based on the edition string, and on-screen candidate items ranked anteriorly are displayed in a candidate bar, that is, this is the conventional word candidate mode, in this case the first state identification is used; then when the method enters the candidate item cursor sliding mode, the first state identification of the current conventional word candidate mode is changed into the third state identification of the edition string cursor sliding mode.

When the sliding event is received continuously, it is determined a type of the current state identification of the input method; if the determined type is the third state identification, it is determined whether a sliding event received continuously in the candidate item cursor sliding mode meets the second switch condition.

In step 114, the method enters an edition string cursor sliding mode and it is determined whether a sliding event received continuously in the edition string cursor sliding mode meets the first switch condition; the method enters step 116, if the sliding event received continuously does not meet the first switch condition; and the method enters step 118, if the sliding event received continuously meets the first switch condition.

In the embodiment of the present disclosure, entering the edition string cursor sliding mode is the precondition for determining whether the first switch condition is met. When the input method enters the edition string cursor sliding mode, it may be determined whether the sliding event received continuously meets the first switch condition. If the sliding event received continuously does not meet the first switch condition, the method enters step 116; and if the sliding event received continuously meets the first switch condition, the method enters step 118.

In the above example, if initial focus coordinates are (10, 10) when a user presses the touch screen and coordinates of the touched focus change as the user slides, for example to coordinates (10, 7), the focus coordinates after sliding are on the lower side of the initial focus coordinates, the sliding event is sliding downward, an angle between a sliding direction and the vertical direction is 0, a sliding distance in the horizontal direction is 3 that reaches the above threshold 3, therefore it is determined that the sliding event meets the first switch condition.

In step 116, the cursor is controlled to move in an edition string based on the sliding event.

If the sliding event in the edition string cursor sliding mode does not meet the first switch condition, the cursor is controlled to move in the edition string based on the sliding event.

In practice, when the user does not move the cursor, the user may click the keys to input a character, such as one or more of a to z.

In the embodiment of the present disclosure, when a certain sliding operation of the user triggers entering the edition string cursor sliding mode and the sliding operation of the user does not end and continues, it can be determined whether the sliding operation meets a second switch condition based on a direction and a distance of continuous sliding. If the second switch condition is not met, the cursor is controlled to move in an edition string; and if the second switch condition is met, it is switched to the candidate item cursor sliding mode. When the sliding operation of the user ends and a sliding event is received again, since the sliding event is received in the edition string cursor sliding mode, it is determined whether the sliding event meets the second switch condition directly based on a direction and a distance of the sliding event. If the second switch condition is not met, the cursor is controlled to move in the edition string; and if the second switch condition is met, it is switched to the candidate item cursor sliding mode.

In substep 1161, based on the sliding direction and the sliding distance, a position of the cursor in the edition string is controlled in a same direction as the sliding direction.

In the present disclosure, a moving direction of the cursor in the edition string is consistent with the horizontal sliding direction described above, that is, a cursor slides towards left when the user slides towards left. FIG. 1D is a schematic diagram obtained from FIG. 1B when the sliding is towards right. The cursor slides towards right when the user slides right. In the embodiment of the present disclosure, in the edition string cursor sliding mode, the cursor moves towards left when the sliding is towards left, but the cursor does not respond to the sliding towards left when the cursor is located at the leftmost of the edition string (.e., a head of the edition string). The cursor moves towards right when it slides towards right, and the cursor does not respond to the sliding towards right when the cursor is located at the rightmost of the edition string (i.e., an end of the edition string).

In addition, the user may exit from the edition string cursor sliding mode, and the method enters step 112 if a sliding event is received again.

Preferably, after the controlling the cursor to move in the edition string based on the sliding event, the method may further includes step 1182.

In step 1182, when the cursor is located at an end of the edition string, the method exits from the edition string cursor sliding mode if a character sequence inputted by the user is received again.

In the embodiment of the present disclosure, when the cursor is located at a position in the edition string other than the end of the edition string, it is indicated that the user may need to change the edition string or adjust the Pinyin string, and the received character input by the user is inserted at the position where the cursor is located. For example, in FIG. 1D, the user continues to input a character u, u is inserted after k, to obtain an edition string “ku | ai'gua”, the cursor is behind u, and the method does not exit from the edition string cursor sliding mode. If the cursor is located at an end of the edition string, as a cursor position shown in FIG. 1B, the user clicks a key to input a character, the method exits from the edition string cursor sliding mode and recovers to the conventional word candidate mode described above.

In practice, when the cursor is not located at the end of the edition string, the key may be clicked to input a character, such as one or more of a to z.

Based on substeps 1123 to 1125 described above, in the embodiment of the present disclosure, when the cursor is located at the end of the edition string, if a character sequence input by the user is received again, the second state identifier of the edition string cursor sliding mode is changed into the first state identification of the conventional word candidate mode.

In step 118, it is switched from the current edition string cursor sliding mode to a candidate item cursor sliding mode.

If a sliding event received in the edition string cursor sliding mode meets a second switch condition, it is switched from the current edition string cursor sliding mode to the candidate item cursor sliding mode, for example to the mode shown in FIG. 1 C to select candidate items. That is, the method proceeds to step 120.

In step 120, the method enters a candidate item cursor sliding mode, and it is determined whether a sliding event received continuously in the candidate item cursor sliding mode meets the second switch condition; the method proceeds to step 122 if the sliding event received continuously does not meet the second switch condition; and the method proceeds to step 124 if the sliding event received continuously meets the second switch condition.

In the embodiment of the present disclosure, entering the candidate item cursor sliding mode is the precondition for determining whether the second switch condition is met. For the input method, when the method enters the candidate item cursor sliding mode, it may be determined further whether the sliding event received continuously meets the first switch condition; the method proceeds to step 122 when the sliding event received continuously does not meet the first switch condition; and the method proceeds to step 124 if the sliding event received continuously meets the first switch condition.

If initial focus coordinates are (7, 5) when a user presses the touch screen and coordinates of the touched focus change as the user slides, for example to coordinates (7, 8), the focus coordinates after sliding are on the upper side of the initial focus coordinates, the sliding event is sliding upward, an angle between a sliding direction and the vertical direction is 0, a sliding distance in the horizontal direction is 3 that reaches the above threshold 3, therefore it is determined that the sliding event meets the second switch condition.

In step 122, a cursor is controlled to move in a candidate item based on the sliding event.

If the sliding event in the candidate item cursor sliding mode does not meet the second switch condition, the cursor is controlled to move in the edition string based on the sliding event.

Preferably, the controlling the cursor to move in the candidate item based on the sliding event may include substep 1221.

In substep 1221, based on a sliding direction and a sliding distance, the cursor is controlled to move in the candidate item in a same direction as the sliding direction.

In the present disclosure, the sliding direction of the cursor in a candidate bar is consistent with the horizontal sliding direction described above, that is, when the user slides towards right, the cursor slides towards right, as shown in FIG. 1C which is a schematic diagram showing that the cursor moves towards right in the candidate item. When the user slides towards right, the cursor slides towards right. In the embodiment of the present disclosure, in the candidate item cursor sliding mode, the cursor is moved towards left when the sliding slides towards left, but when the cursor is located at leftmost of the candidate bar, the candidate item is moved without movement of the cursor. The cursor is moved towards right when the sliding slides towards right, but when the cursor is located at rightmost of the candidate bar, the candidate item is moved without movement of the cursor.

In addition, the user may exit from the candidate item cursor sliding mode, and the method proceeds to step 112 when a sliding event is received again.

Preferably, after the controlling the cursor to move in the candidate item based on the sliding event, the method may further includes substep S1221.

In substep S1221, the method exits from the candidate item cursor sliding mode, if a character sequence input by a user is received again.

In the embodiment of the present disclosure, the character input by the user is received continuously in the candidate item cursor sliding mode. For example, when u is input in the Pinyin input method, it is indicated the edition string changes, accordingly the candidate item changes, and thus the method may exit from the candidate item cursor sliding mode.

Based on substeps 1126 to 1128 described above, in the embodiment of the present disclosure, if a character sequence input by the user is received again, a third state identification of the edition string cursor sliding mode is changed into the first state identification of the conventional word candidate mode.

Preferably, the controlling the cursor to move in the candidate item based on the sliding event may include substeps S1122 to S1125.

In substep S1122, when the cursor is moves to a last candidate item displayed in the candidate bar, it is determined whether the last candidate item displayed in the candidate bar is an end candidate item if a sliding event towards the end of the candidate item is received continuously.

In substep S1123, if the last candidate item displayed in the candidate bar is not the end candidate item, candidate items displayed in the candidate bar are moved successively towards the head.

In the embodiment of the present disclosure, the number of candidate items displayed simultaneously in the candidate bar is limited. For example, about four candidate items can only be displayed in FIG. 1C. In practice, the number of candidate items corresponding to one edition string or a key sequence input by the user is generally much greater than the number of candidate items which can be displayed in the candidate bar. When the cursor moves to the last candidate item displayed in the candidate bar, for example “ [symbol] ” shown in FIG. 1C, it is determined whether “ [symbol] ” is the last candidate item according to all ordering. If “ [symbol] ” is not the last candidate item, for a sliding event towards right, all candidate items need to be moved successively towards the head when the cursor corresponds to a candidate item behind the current candidate item, such that the cursor located at the end of the candidate bar can correspond to a corresponding candidate item. In the embodiment of the present disclosure, “ [symbol] ” in FIG. 1 is obtained by moving the cursor towards right and moving all the candidate items towards left in FIG. 1A. If “ [symbol] 38 is the last candidate item, no response is performed to the sliding towards right.

In substep S1124, when the cursor moves the first candidate item displayed in the candidate bar, it is determined whether the first candidate item displayed in the candidate bar is a head candidate item if a sliding event towards the head of the candidate item is received continuously.

In substep S1125, if the first candidate item displayed in the candidate bar is not the head candidate item, each candidate item displayed in the candidate bar is moved successively towards the end.

According to the logic described above, if the cursor moves to a position of the first candidate item of the candidate column, for example, moves to “ [symbol] ” in FIG. 1A, it is determined whether “ [symbol] ” is a first candidate item in all candidate items. If “ [symbol] ” is not the candidate item ranked firstly in all candidate items, for a sliding event towards left, all candidate items are moved right successively. If “ [symbol] ” is the candidate item ranked firstly in all the candidate items, no response is performed to the left sliding.

Preferably, after the controlling the cursor to move in the candidate item based on the sliding event, the method may further include substep S1126.

In substep S1126, a corresponding edition string is corrected based on a candidate item corresponding to a position to which the cursor moves.

In the embodiment of the present disclosure, for candidate items, candidate items corresponding to various types of edition strings may be selected based on a key sequence. For example, the key sequence “524482” in the above example corresponds to at least two Pinyin strings, such as “kai'hua” and “kai' gua”, thus various word and/or words of the Pinyin string may function as candidate items. In FIG. 1 and FIG. 1C, an initial Pinyin string is “kai'gua”; when it enters the candidate item cursor sliding mode, the cursor is moved towards right to “ [symbol] ”, and the Pinyin string is adjusted as “kai'hua”.

In step 124, the mode is switched from the current candidate item cursor sliding mode to the edition string cursor sliding mode.

If the sliding event received in the candidate item cursor sliding mode meets the second switch condition, the mode is switched from the current candidate item cursor sliding mode to the edition string cursor sliding mode, for example to the mode in FIG. 1A. That is, the method proceeds to step 114.

With the cursor operation method for the input method according to the present disclosure, the sliding event received in the region of the input method can be monitored in an interface of the conventional word candidate mode of the input method; it is determined whether the sliding event received continuously meets a preset mode condition; the method enters the edition string cursor sliding mode, and it is determined whether the sliding event received continuously in the edition string cursor sliding mode meets a first switch condition, such that the following problem is solved: if the user needs to input the cursor in the edition string to modify the edition string, the user needs to click a certain position in the edition string; a display region of the edition string is narrow, the user is difficult to accurately click a desired position on a touch screen; and the clicking action of the user will shelter the edition string, thereby influencing accuracy of the user operation. With the method according to the present disclosure, it is convenient for the user to control the cursor for the input method to enter the edition string and move in the edition string based on the sliding operation in the input method, and sight of the user is not influenced, such that the user can accurately position the cursor.

In addition, with the cursor operation method for the input method according to the present disclosure, the sliding event received in the region of the input method can be monitored in an interface of the conventional word candidate mode of the input method; it is determined whether the sliding event received continuously meets a preset mode condition; the method enters the candidate item cursor sliding mode if the sliding event meets the second type of preset mode condition; and it is determined whether the sliding event received continuously in the candidate item cursor sliding mode meets a second switch condition, such that the following problem is solved: for the input method, the candidate items obtained based on the edition string are displayed in the candidate bar; if the user needs to select more candidate items, the user needs to click an unfold button to unfold a candidate interface for selection; the candidate interface will cover the input method keyboard, and a new candidate item cannot be directly displayed in the candidate bar by the cursor of the candidate bar. With the method according to the present disclosure, it is convenient for the user to control the cursor for the input method to enter the candidate bar and move in the candidate item based on the sliding operation in the input method, and sight of the user is not influenced, such that the user can select the candidate items more conveniently.

In the present disclosure, after the method enters the edition string cursor sliding mode or the candidate item cursor sliding mode, it is determined whether the received sliding event meets a mode switch condition between the edition string cursor sliding mode and the candidate item cursor sliding mode. If the received sliding event meets the mode switch condition between the edition string cursor sliding mode and the candidate item cursor sliding mode, it is switched from the current cursor sliding mode to another cursor sliding mode. Modes may be directly switched between the edition string cursor sliding mode and the candidate item cursor sliding mode, such that flexibility of mode conversion is improved and it is convenient for the user to switch the cursor sliding mode more quickly, to select the candidate item or edit the edition string.

Mode may be switched to the edition string cursor sliding mode or the candidate bar cursor sliding mode in the interface of the conventional word candidate mode of the input method; and when the method enters the edition string cursor sliding mode or the candidate bar cursor sliding mode, switch may be performed between the two modes. In the edition string cursor sliding mode, the position of the cursor in the edition string may be changed by the sliding operation in the input region, and operations such as editing may performed on the edition string. In the candidate item cursor sliding mode, the position of the cursor in the candidate item string may be changed by the sliding operation in the input region, such that the following problem is solved: if the user needs to input the cursor in the edition string to modify the edition string, the user needs to click a certain position in the edition string; a display region of the edition string is narrow, the user is difficult to accurately click a desired position in the touch screen; the click action of the user will shelter the edition string, accuracy of the user operation is influenced more; if the user needs to select more candidate items, the user needs to click an unfold button to unfold a candidate interface for selection; but the candidate interface will cover the input method keyboard, a new candidate item cannot be directly displayed in the candidate bar by the cursor of the candidate bar. With the method according to the present disclosure, it is convenient for the user to control the cursor of the input method to enter the edition string and to move in the edition string based on the sliding operation in the input method, sight of the user is not influenced, such that the user can position the cursor more accurately; and it is convenient for the user to control the cursor for the input method to enter the candidate bar and move in the candidate bar based on the sliding operation in the input method, sight of the user is not influenced, such that the user can select the candidate item more conveniently.

In addition, in the present disclosure, after it enters the edition string cursor sliding mode or the candidate item cursor sliding mode, it is determined whether the received sliding event meets a mode switch condition between the edition string cursor sliding mode and the candidate item cursor sliding mode; if the received sliding event meets the mode switch condition between the edition string cursor sliding mode and the candidate item cursor sliding mode, it is switched from the current cursor sliding mode to another cursor sliding mode. It can be directly switched between the edition string cursor sliding mode and the candidate item cursor sliding mode, flexibility of mode conversion is improved, and it is convenient for the user to switch the cursor sliding mode more quickly to select the candidate item or edit the edition string.

### Second Embodiment

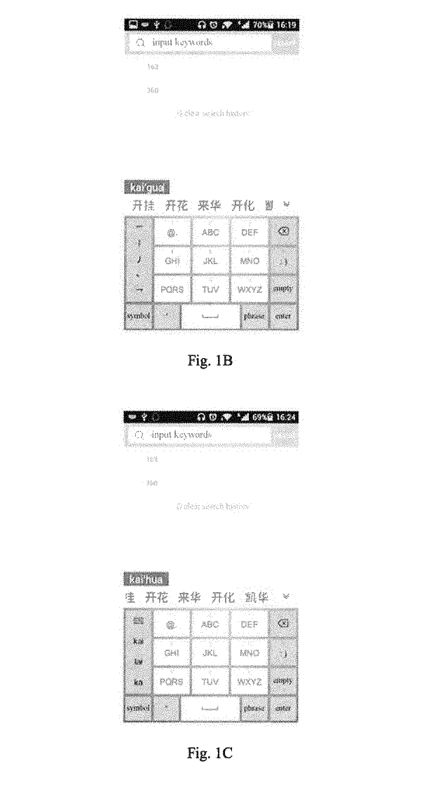

Reference is made to FIG. 2 which shows a schematic flowchart of a cursor operation method for an input method according to the present disclosure. The method may include step 210 to step 228 in the following.

In step 210, it is monitored whether a sliding event is received in a conventional word candidate mode of the input method.

In step 212, it is determined whether the sliding event meets a type of a preset mode condition if the sliding event is received; the method proceeds to step 214 if the sliding event meets a first type of preset mode condition; and the method proceeds to step 228 if the sliding event meets a second type of preset mode condition.

In step 214, it enters an edition string cursor sliding mode; it is determined whether a sliding event received continuously in the edition string cursor sliding mode meets a first switch condition; the method proceeds to step 216 if the sliding event received continuously does not meet the first switch condition; and the method proceeds to step 226 if the sliding event received continuously meets the first switch condition.

In step 216, a cursor is controlled to move in an edition string based on the sliding event.

In the present disclosure, when it enters the edition string cursor sliding mode, it will trigger a stroke screening mode to generate a stroke input interface, so as to receive screening stroke sequences input by the user, for example, “horizontal, vertical, vertical”, strokes of a Chinese character are divided by “horizontal, vertical, left-falling, right-falling and turning”, such as “ [symbol] ”, the user may click the 5 keys to input strokes, for example an interface where “ [symbol] ” is located in FIG. 1B.

After the controlling the cursor to move in the edition string based on the sliding event, the method may further include step 218 to step 224 in the following.

In step 218, a key subsequence corresponding to the cursor is determined.

In the present disclosure, after the cursor in the edition string is moved, such as the status after moving is “kai' | gua” or “kai | ‘gua” or “kai' gu | a”, a corresponding key sub-sequence in 524482 may be positioned by position of the cursor “| ”. For example, a key sequence of a first Pinyin substring after the cursor is positioned, a corresponding key sub-sequence for “kai' | gua” or “kai | ‘gua” is 482. For “kai' gu | a”, the Pinyin string where the cursor is located is positioned as gua, and the corresponding key sub-sequence is 482.

In step 220, screening stroke sequences input by the user are received.

For example, if the user inputs “ [symbol] ”, the input method receives the screening stroke sequence “ [symbol] ”.

In step 222, the screening stroke sequence is matched with first stroke sequence of initial candidate items corresponding to the key sub-sequence.

In the input method, for a certain key sub-sequence, a corresponding Pinyin string may have many forms and corresponding word and/or words may have different types. For example for 482 described above, the corresponding Pinyin string may include “gua” and “hua”, each Pinyin string corresponds to a series of initial candidate items in a lexicon. In the present disclosure, the screening stroke sequence may be matched with first stroke sequences of the initial candidate items. For the matched initial candidate item, the method proceeds to step 370.

It should be understood that, before matching in the step, Pinyin substrings formed by the key sub-sequences are acquired by the key sub-sequences, corresponding initial candidate items are extracted from a lexicon based on the Pinyin substrings, and the initial candidate items of each Pinyin substring are combined as an initial candidate item corresponding to the key sub-sequence.

In practice, in the embodiment of the present disclosure, for selection of the initial candidate items, initial candidate items which can be combined with other Pinyin strings to form words/sentence are matched with a higher priority. For “kai [symbol] ‘gua”, the Pinyin string kai is not processed; the later 482 corresponds to “gua” or “hua”, word in a phrase corresponding to Pinyin string combinations such as “kai' gua” and “kai' hua” are selected with a higher priority, such as words behind “kai” in the phrases “ [symbol] [symbol] ”, “ [symbol] ” and “ [symbol] ”, and then a single word which cannot form phrases is selected to be matched.

For the screening stroke sequence “ [symbol] ” in the above example, “ [symbol] ” is matched in the initial candidate items of 482.

In step 224, based on the matched initial candidate items, the Pinyin substrings corresponding to the key sub-sequence and a later key sub-sequence are corrected, and corresponding on-screen candidate items are corrected.

In the above example, for the on-screen Pinyin string “kai' gua”, the on-screen candidate item is “ [symbol] ”. Since initial candidate items of 482 are filtered in the above step to obtain “ [symbol] ”, a Pinyin string of “ [symbol] ” is “hua”, the on-screen Pinyin string is modified as “kai' hua”, on-screen candidate items such as “ [symbol] ” are removed, and it is modified as on-screen candidate items of “kai' hua”, that is, “ [symbol] ” and “ [symbol] ” ranks anteriorly.

Preferably, in step 218, the determining the key sub-sequence corresponding to the cursor includes substep 2181 to 2183.

In substep 2181, the cursor is located at a first position of the Pinyin string, and it is determined whether the first position is in a Pinyin substring conforming to a Pinyin rule.

In substep 2182, if the first position is not in the Pinyin substring conforming to the Pinyin rule, a corresponding key sub-sequence is selected from a first Pinyin substring conforming to Pinyin rule after the first position, as a key sub-sequence corresponding to the cursor.

In substep 2183, if the first position is in the Pinyin substring conforming to the Pinyin rule, a corresponding key sub-sequence is selected from a Pinyin substring conforming to the Pinyin rule where the first position is located, as the key sub-sequence corresponding to the cursor.

In practice, in the embodiment of the present disclosure, it may be provided that a key sequence of only one Pinyin substring conforming to the Pinyin rule is selected as the key sub-sequence corresponding to the cursor, or key sequences of multiple Pinyin substrings conforming to the Pinyin rule are selected as the key sub-sequence corresponding to the cursor.

For example, taking the nine key keyboard as an example, when the user inputs 9494268426, the input method identifies as a default Pinyin string “yi' xian' tian”, a default on-screen candidate item includes “ [symbol] ” and the like. If it is provided that a key subsequence of one Pinyin substring conforming to the Pinyin rule is selected as the key sub-sequence corresponding to the cursor, then:

when the user inputs the positioning cursor in “y | i' xian' tian”, since the positioning cursor “| ” is before a, the positioning cursor is in the Pinyin string yi based on the Pinyin rule of Chinese Pinyin, the key subsequence 94 corresponding to yi is selected as the key sub-sequence corresponding to the positioning cursor.

When the user inputs the positioning cursor in “y i+ | xian'tian”, since the positioning cursor “| ” is before the last x the positioning cursor is not in a certain Pinyin substring based on the Pinyin rule of Chinese Pinyin, a first Pinyin substring after the cursor is xian, the key sequence 9426 corresponding to xian is selected as the key sub-sequence corresponding to the positioning cursor.

When the user inputs the positioning cursor in “y i' xi | an' tian”, since the positioning cursor “| ” is before a, the positioning cursor is in a Pinyin substring xian based on the Pinyin rule of Chinese Pinyin, the key sequence 9426 corresponding to xian is selected as the key sub-sequence corresponding to the positioning cursor.

When the user inputs the positioning cursor in “y i' xian' | tian”, the positioning cursor “| ” is before a last i, the positioning cursor is not in a certain Pinyin substring based on the Pinyin rule of Chinese Pinyin, a first Pinyin substring after the cursor is tian, therefore the key sequence 8426 corresponding to tian is selected as the key sub-sequence corresponding to the positioning cursor.

In practice, if multiple Pinyin strings are selected as key subsequences corresponding to the positioning cursor, for example “y i' xi | an' tian” described above, “9246” and “8426” are selected as the key sub-sequences corresponding to the positioning cursor. Words and/or phrases corresponding to the two key sub-sequences may be screened simultaneously for subsequent stroke screening sequences. Other cases are similar.

In practice, based on the first position of the positioning cursor in the Pinyin string, it is determined whether there is a Pinyin substring conforming to the Pinyin rule before the first position; if there is a Pinyin substring conforming to the Pinyin rule before the first position, a key sub-sequence after the Pinyin substring conforming to the Pinyin rule is made as the key sub-sequence corresponding to the positioning cursor; and if there is no Pinyin substring conforming to the Pinyin rule before the first position, the key sub-sequence starting from the first key is made as the key sub-sequence corresponding to the positioning cursor.

Preferably, in step 222, the matching the screening stroke sequences with first stroke sequences of each initial candidate item corresponding to the key sub-sequence may include substeps 2221 to 2223.

In substep 2221, Pinyin substrings corresponding to the key sub-sequence are searched for.

In substep 2222, corresponding words and/or phrases are acquired from the Pinyin strings, to obtain initial candidate items.

In substep 2223, the screening stroke sequences are matched with the stroke sequences of each initial candidate item.

Taking the key sequence 9426 corresponding to “y i' | xian' tian” as an example, it may correspond to Pinyin substrings such as “xian”, “xiao” and “zhao”, the Pinyin substrings correspond to a series of words, and the words can be used as initial candidate items to screen the screening stroke sequence.

Based on substeps 2221 to 2223 combining with step 224, in order to conveniently understand the embodiment of the present disclosure, it is illustrated using the examples above here. For example, if the user inputs 9494268426, the input method identifies as a default Pinyin string “yi' xian' tian”, and a default on-screen candidate item includes “ [symbol] ” and so on.

In a first case, the user inputs the positioning cursor to obtain “y i' | xian' tian”; according to the above steps, a key sub-sequence corresponding to the positioning cursor is determined as 94. When the user inputs the screening stroke sequence “ [symbol] ”, according to the above steps, words corresponding to 94 are screened to obtain “ [symbol] ”, yi in “yi' xian' tian” is modified to xi by default. In practice, the Pinyin substring after yi may be modified accordingly or not. For a case without modification, the Pinyin substring may be “xi' xian' tian”, a first word of an on-screen candidate screen is [symbol] , and other words may be searched for from a lexicon based on the subsequent Pinyin substrings.

In a second case, when the user inputs the positioning cursor to obtain “y i' |xian' tian”, according to the above steps, a key sub-sequence corresponding to the positioning cursor may be determined as 9426. When the user inputs the screening stroke sequence “ [symbol] ”, according to the above steps, words corresponding to 9426 are screened to obtain “ [symbol] ”, therefore xian in “yi' xian' tian” may be modified as xiao, and the Pinyin substing after xian may be modified accordingly or not. For a case without modification, the Pinyin substring may be “yi' xiao' tian”, a first word of an on-screen candidate item is still [symbol] , a second word is [symbol] , and a third word may be a word which may form a phrase with the second word, such as [symbol] . ther on-screen candidate items may be searched for from a lexicon based on the subsequent Pinyin substring.

In a third case, the user inputs the positioning cursor to obtain “y i' | xian' tian”, according to the above steps, the key sub-sequence corresponding to the positioning cursor may be determined as 94268426.

In this case, since strokes of multiple words may be matched, it may be provided in advance that a first stroke sequence formed by at least first strokes of multiple words is to be matched. For example, first strokes of words are matched. When the user inputs the screening stroke sequence “ [symbol] ”, according to the above steps, words corresponding to 94268426 are screened to obtain “ [symbol] ”. In practice, if there are multiple words and/or phrases of which strokes are matched, it may be selected based on a use frequency, and words and/or phrases with a high use frequency are selected firstly.

Xian' tian in “yi' xian' tian” may be modified as xiao' tian by default, the first word of the on-screen candidate item is [symbol] , and the second and third words are [symbol] . Other on-screen candidate items may be searched for from a lexicon based on the subsequent Pinyin substring.

Preferably, in step 222, the matching the screening stroke sequences with stroke sequences of initial candidate items corresponding to the key sub-sequence may include substep B2241.

In substep B2241, the screening stroke sequence input by the user is matched with first stroke sequence formed by at least first strokes of each word of each initial candidate item.

In the embodiment of the present disclosure, the key sub-sequence corresponding to the positioning cursor may correspond to several Pinyin strings, and each Pinyin string corresponds to multiple initial candidate items. Therefore, each key sub-sequence corresponds to more initial candidate items by the corresponding Pinyin string. For example, it is provided in the step that multiple Pinyin substrings conforming to the Pinyin rule after the first position corresponding to the positioning cursor or on the first position are obtained, the multiple key sub-sequences corresponding to the multiple Pinyin substrings are used as the key sub-sequences corresponding to the positioning cursor. The key sub-sequence may correspond to phrases, for example in the second embodiment, 94268426 may correspond to “xiao'tian” and “xian'tian”, each of the Pinyin strings corresponds to two words, or it may be understood that each of the Pinyin strings corresponds to one phrase. In the present disclosure, multiple words of one initial candidate item may be matched simultaneously by the screening stroke sequence.

Preferably, the matching the screening stroke sequence input by the user with the first stroke sequence formed by at least first strokes of words of each initial candidate items may include substep B2242 and/or substep B2243.

In substep B2242, the screening stroke sequence is matched with the first stroke sequence formed by all strokes of each word of each initial candidate items.

In the embodiment of the present disclosure, all strokes of each word of the initial on-screen candidate item may be extracted, to form the first stroke sequence. For example, for “ [symbol] ”, all strokes of “ [symbol] ” include “ [symbol] ”, and all strokes of “ [symbol] ” include [symbol] , the formed first stroke sequence is [symbol] , and the screening stroke sequence may be matched with the first stroke sequence.

In substep B2234, the screening stroke sequence may be matched with a first stroke sequence formed by first stroke of each word of each candidate item.

In the embodiment of the present disclosure, full strokes of each word of the initial on-screen candidate item may be extracted to form the first stroke sequence. For example, for “ [symbol] ” described above, a first stroke of “ [symbol] ” is “ [symbol] ”, and a first stroke of “ [symbol] ” is “ [symbol] ”, the formed first stroke sequence is “ [symbol] ”, and the screening stroke sequence may be matched with the first stroke sequence.

Preferably, before the screening stroke sequence input by the user is matched with the first stroke sequence formed by at least first strokes of each word of each initial candidate item, the method further includes substep B2244.

In substep B2244, for each initial candidate item, a first stroke sequence of each initial candidate item is acquired from a lexicon.

In the embodiment of the present disclosure, stokes of each word may be stored in the lexicon in advance, and the lexicon may be installed in a specified path of the system together with a client when installed.

In the embodiment of the present disclosure, before, during or after the process during which the screening stroke sequence input by the user is received, a first stroke sequence of each initial on-screen candidate item may be extracted from the lexicon. In practice, as described in the first embodiment, the first stroke sequence formed by at least first strokes of each word of each initial on-screen candidate item may be extracted.

Preferably, the matching the screening stroke sequence input by the user with the first stroke sequence formed by at least first strokes of each word of each initial candidate item further includes substeps B2245 and B2246.

In substep B2245, when the screening stroke sequence is not completely matched with the first stroke sequence of the initial candidate item, a probability that the stroke sequence input by the user is matched with the first stroke sequence of the initial candidate item is determined by using an error correction model based on strokes.

In an actual application, when the user inputs the screening stroke sequence, an error may occur. For example, when inputting word “ [symbol] ”, taking “ [symbol] ” of Five-stroke input method as an example, the correct stroke order should be “ [symbol] ”, an error may occur for “ [symbol] ”, for example, “ [symbol] ”, such error may be determined based on the error correction model based on strokes, and a probability that the stroke sequence input by the user is matched with the first stroke sequence of the initial on-screen candidate item is determined.

In substep B2246, when the matched probability is greater than a threshold, it is determined that the screening stroke sequence is successfully matched with the first stroke sequence of the initial candidate item.

When it is determined that the probability that the stroke sequence input by the user is matched with the first stroke sequence of the initial on-screen candidate item is greater than a certain threshold by the error correction model based on strokes, it is determined that the screening stroke sequence is successfully matched with the first stroke sequence of the initial on-screen candidate item; otherwise, the screening stroke sequence is not matched with the first stroke sequence.

Preferably, the method further includes substep B2247 and/or substep B2248.

In substep B2247, an error correction model based on strokes is created by using a binary or multiple relationship of words in a phrase and/or sentence.

The binary relationship is used to indicate a probability that two elements appear sequentially, i.e., P(B|A), which indicates a probability that B occurs in a case that A occurs. The multiple relationship is derived from the binary relationship.

In the embodiment of the present disclosure, strokes of phrases and words may be counted in advance, a probability that strokes appear is determined based on direct words and direct binary or multiple relationship in the phrase or the sentence. For example, stroke sequences of [symbol] is “ [symbol] ”, it is obtained by counting that a probability of “ [symbol] ” corresponding to [symbol] [symbol] is 90%, and a probability “ [symbol] ” of corresponding to [symbol] is 79%, and so on, thereby creating an error correction model based on strokes. For example, for the screening stroke sequence not matched with the initial on-screen candidate item, a matching probability between the screening stroke sequence and the initial on-screen candidate item may be determined based on the error correction model based on strokes. If the matching probability is greater than a threshold, for example greater than 60%, it is considered that the initial on-screen candidate item is successfully matched.

In substep B 2248, an error correction model based on strokes is created by using a binary or multiple relationship between strokes of each word.

For example, strokes of “ [symbol] ” includes “ [symbol] ”, it is obtained by counting that a probability of “ [symbol] ” corresponding to “ [symbol] ” is 90% and a probability of “ [symbol] ” corresponding to “ [symbol] ” is 80%, and a similar principle may be used to create an error correction model based on strokes. A matching probability between the screening stroke sequence and each initial on-screen candidate item may be determined based on the error correction model based on strokes. If the matching probability is greater than a threshold, for example greater than 60%, it is considered that the initial on-screen candidate item is successfully matched.

Preferably, the receiving the screening stroke sequence input by the user includes substep B2249.

In substep B2249, it is determined whether there is a separator in the screening stroke sequence; and the screening stroke sequence input by the user is divided into screening stroke sub-sequences by the separator, if there is the separator.

Further, the matching the screening stroke sequence input by the user with the first stroke sequence formed by at least first strokes of each word of each initial candidate item includes substep B 2250.

In substep B2250, by taking the screening stroke sub-sequence as a unit, the screening stroke sub-sequences are sequentially matched with a target stroke sub-sequence of a word at a corresponding position of each initial candidate item.

In the embodiment of the present disclosure, a separator identification rule may be preset. For example, “ [symbol] ” or “ [symbol] ” is set as the separator, the user may input the separator between the input screening strokes, to divide the screening stroke sequence into screening stroke sub-sequences, and each screening stoke sub-sequence may correspond to a screening stroke sequence of one word.

If there is no separator, the screening stroke sequence is sequentially matched with the first stroke sequence formed by at least strokes of each word of each initial on-screen candidate item.

For example, if the user input the separator “ [symbol] ” after inputting “ [symbol] ”, it can be determined that “ [symbol] ” is a screening stroke sub-sequence of a first word of the screening initial on-screen candidate item. After inputting the separator, the user continues to input “ [symbol] “ [symbol] “ [symbol] ” may be made as a screening stroke sub-sequence of a second word of the screening initial on-screen candidate item. If there is another separator, a screening stroke sub-sequence between two separators is matched correspondingly with the word at the corresponding position of the initial on-screen candidate item. For example, there are two separators, a screening stroke sequence before the first separator is matched correspondingly with a first word of the initial on-screen candidate item, a screening stroke sub-sequence between the first separator and the second separator is matched correspondingly with a second word of the initial on-screen candidate item, and a screening stroke sequence after the second separator is matched correspondingly with a third word of the initial on-screen candidate item.

Substeps B2249 and B2250 may be performed when a first stroke sequence formed by at least first two strokes of each word of the initial candidate item is to be matched, thereby improving the identification speed of the screening stroke sequence and improving a matching efficiency.

In step 226, it is switched from the current edition cursor sliding mode to the candidate item cursor sliding mode.

In step 228, the method enters the candidate item cursor sliding mode, and it is determined whether a sliding event received continuously in the candidate item cursor sliding mode meets a second switch condition; the method proceeds to step 230 if the sliding event received continuously does not meet the second switch condition; and the method proceeds to step 232 if the sliding event received continuously meets the second switch condition.

In step 230, a cursor is controlled to move in a candidate item based on the sliding event.

In step 232, it is switched from the current candidate item cursor sliding mode to the edition string cursor sliding mode.

In the embodiment of the present disclosure, firstly, two types of cursor sliding modes are provided, i.e., the edition string cursor sliding mode and the candidate item cursor sliding mode; the user may change the conventional word candidate mode to a certain cursor sliding mode by triggering a predetermined sliding event, such that it is convenient for the user to edit the edition string and select the candidate item, and it is convenient for the user to select the candidate item in a case of having a candidate item sight.

In addition, in the embodiment of the present disclosure, particularly in the edition string cursor sliding mode, based on the key subsequence corresponding to the position of the positioning cursor, various words and/or phrases corresponding to the Pinyin strings corresponding to the key sequence (i.e., the initial candidate item) are screened based on a screening stroke sequence input by the user again; it does not need to determine Pinyin and then determine the on-screen candidate item, the on-screen candidate item can be determined by the screening stroke sequence while correcting corresponding Pinyin substrings. The following problem is solved: during a process of determine a candidate Chinese character, the candidate item can be obtained only when the Pinyin is determined, the operation process is complex, further screening cannot be performed, and an input efficiency of the user is influenced. With the embodiment of the present disclosure, the flexibility for using the positioning cursor by the user is improved, the on-screen candidate item is further screened, thereby improving input efficiency of the user. In addition, in the embodiment of the present disclosure, multiple words of the initial candidate item can be screened by multiple strokes, it is not limited to screening of a single word, and a screening efficiency is high, thereby further improving the input efficiency.

Lastly, modes can be directly switched between two types of cursor sliding modes. It does not need to switch into another sliding mode by another sliding event by returning to the word candidate mode each time, in a certain sliding mode. The flexibility of mode conversion is improved, and it is convenient to switch the cursor sliding mode more quickly, to select the candidate item or edit the edition string.

### Third embodiment

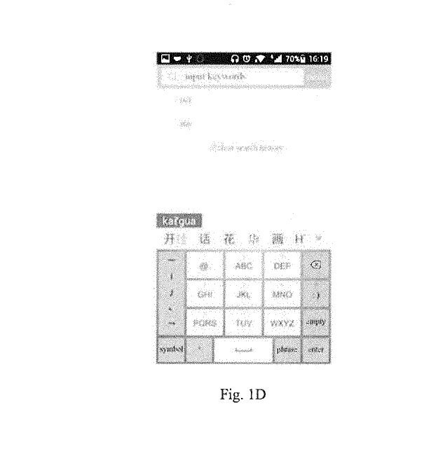

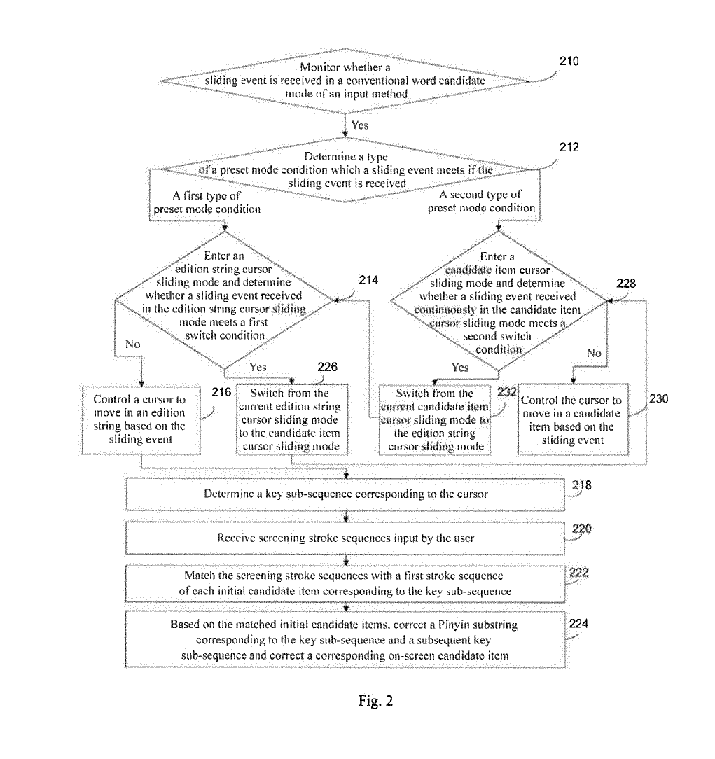

Reference is made to FIG. 3 which shows a schematic structural diagram of a cursor operating device for an input method according to the present disclosure. Specifically, the device includes a sliding monitoring module 310, a type determining module 312, an edition cursor mode executing module 314, an edition cursor moving module 316, a first cursor mode switching module 318, a candidate cursor mode executing module 320 and a candidate cursor moving module 322.

The sliding monitoring module 310 is adapted to monitor whether a sliding event is received in a conventional word candidate mode of the input method.

The type determining module 312 is adapted to determine a type of a preset mode condition which a sliding event meets, if the sliding event is received; enter the edition cursor mode executing module 314 if the sliding event meets a first type of preset mode condition; and enter the candidate cursor mode executing module 320 if the sliding event meets a second type of preset mode condition.

The edition cursor mode executing module 314 is adapted to enter an edition string cursor sliding mode; determine a sliding event received continuously in the edition string cursor sliding mode meets a first switch condition; enter the edition cursor moving module 316 if the sliding event received continuously does not meet the first switch condition; and enter the first switch mode switch module 318 if the sliding event received continuously meets the first switch condition.

The edition cursor moving module 316 is adapted to control a cursor to move in an edition string based on the sliding event.

The first cursor mode switching module 318 is adapted to switch from the current edition string cursor sliding mode to the candidate item cursor sliding mode.

The candidate cursor mode executing module 320 is adapted to enter the candidate item cursor sliding mode; determine whether a sliding event received continuously in the candidate item cursor sliding mode meets a second switch condition; enters the candidate cursor moving module 322 if the sliding event received continuously does not meet the second switch condition; and enter the second cursor mode switch module 324, if the sliding event received continuously meets the second switch condition.

The candidate cursor moving module 322 is adapted to control the cursor to move in the candidate item based on the sliding event.

The second cursor mode switch module 324 is adapted to switch from the current candidate item cursor sliding mode to the edition string cursor sliding mode.

Preferably, for the sliding event, the first switch condition is sliding downward in a case that an angle between a sliding direction and a vertical direction is less than an angle; and the second switch condition is sliding upward in a case that the angle between the sliding direction and the vertical direction is less than a threshold.

Preferably, the edition cursor mode executing module includes: a first state identification switch module, a first state identification determining module and a first cursor moving module.

The first state identification switch module is adapted to modify a first state identification of the current conventional word candidate mode into a second state identification of the edition string cursor sliding mode, if the sliding event meets a first type of preset mode condition.

The first state identification determining module is adapted to determine whether the current state identification of the input method is the second state identification, if a sliding event is received continuously.

The first cursor moving module is adapted to whether the sliding event received continuously in the edition string cursor sliding mode meets a first switch condition, if the state identification of the current input method is the second state identification.

Preferably, the candidate cursor mode executing module includes a second state identification switch module and a second cursor moving module.

The second state identification switch module is adapted to modify a first state identification of the current conventional word candidate mode into a third state identification of the candidate item cursor sliding mode, if the sliding event meets a second type of preset mode condition.

The second state identification determining module is adapted to determine whether a sliding event received continuously in the candidate item cursor sliding mode meets a second switch condition, if the current state identification of the input method is the third state identification.

The second cursor moving module is adapted to determine whether a sliding event received continuously in the candidate item sliding mode meets a second switch condition, if the current state identification of the input method is the third state identification.

Preferably, the type determining module includes a head determining module and an end determining module.

The head determining module is adapted to determine that a sliding event meets a first type of preset mode condition, when the sliding event is a sliding operation towards a head direction of an edition string in a keyboard region of the input method.

The end determining module is adapted to determine that the sliding event meets a second type of preset mode condition, when the sliding event is a sliding operation towards an end direction of a candidate item in the keyboard region of the input method.

Preferably, the edition cursor mode executing module includes a first equidirectional moving module.

The first equidirectional moving module is adapted to control, based on a sliding direction and a sliding distance, a position of the cursor in the edition string in a same direction as the sliding direction.

Preferably, in addition to the edition string cursor mode executing module, the device further includes an edition string cursor sliding mode exiting module.

The edition string cursor mode exiting module is adapted to, when the cursor is located at an end of the edition string, exit from the edition string cursor sliding mode if a character sequence input by the user is received again.

Preferably, the candidate cursor mode executing module includes a second synchronous moving module.

The second equidirectional moving module is adapted to control, based on a sliding direction and a moving distance, a cursor to move in a candidate item in a same direction as the sliding direction.

Preferably, in addition to the candidate cursor mode executing module, the device further includes a candidate item cursor sliding mode exiting module.

The candidate item cursor sliding mode exiting module is adapted to exit from the candidate item cursor sliding mode, if a character sequence input by the user is received again.

Preferably, the candidate cursor mode executing module includes a first candidate item moving determining module and a second candidate item moving determining module.

The first candidate item moving determining module is adapted to, when the cursor moves to a last candidate item displayed in a candidate bar, determine whether the last candidate item displayed in the candidate bar is an end candidate item if a sliding event towards an end of the candidate item is received continuously; and move successively the candidate items displayed in the candidate bar if the last candidate item displayed in the candidate bar is not the end candidate item.

The second candidate item moving determining module is adapted to, when the cursor moves to a first candidate item displayed in the candidate bar, determine whether the first candidate item displayed in the candidate bar is a head candidate item if a sliding event towards a head of the candidate item is received continuously; and move successively candidate items displayed in the candidate bar towards the end if the first candidate item displayed in the candidate bar is not the head candidate item.

Preferably, the candidate cursor mode executing module includes a highlighting displaying module.

The highlighting displaying module is adapted to highlight a candidate item corresponding to the cursor.

Preferably, in addition to the cursor moving module, the device further includes an edition string correcting module.

The edition string correcting module is adapted to correct a corresponding edition string based on a candidate item at a position to which the cursor moves.

### Fourth Embodiment

Reference is made to FIG. 3 which shows a schematic structural diagram of a cursor operating device for an input method according to the present disclosure. The device may include: a sliding monitoring module 410, a type determining module 12, an edition cursor mode executing module 414, an edition cursor moving module 416, a cursor determining module 418, a screening sequence receiving module 420, a screening matching module 422, and an adjusting module 424.

The sliding monitoring module 410 is adapted to monitor whether a sliding event is received in a conventional word candidate mode of the input method.

The type determining module 412 is adapted to determine a type of a preset mode condition which a sliding event meets, if the sliding event is received; enter an edition cursor mode executing module 414, if the sliding event meets a first type of preset mode condition; and enter the candidate cursor mode executing module 428 if the sliding event meets a second type of preset mode condition.

The edition cursor mode executing module 414 is adapted to enter an edition string cursor sliding mode; determine whether a sliding event received continuously in the edition string cursor sliding mode meets a first switch condition; enter the edition cursor moving module 416 if the sliding event received continuously does not meet a first switch condition; and enter the first cursor mode switch module 426 if the sliding event received continuously meets the first switch condition.

The edition cursor moving module 416 is adapted to control a cursor to move in an edition string based on the sliding event and connect to the cursor determining module 418.

The cursor determining module 418 is adapted to determine a key sub-sequence corresponding to the cursor.

The screening sequence receiving module 420 is adapted to receive a screening stroke sequence input by the user.

The screening matching module 422 is adapted to match the screening stroke sequence with first stroke sequence of each initial candidate item corresponding to the key sub-sequences.

The adjusting module 424 is adapted to, based on the matched initial candidate items, correct a Pinyin substring corresponding to the key sub-sequence and a subsequent key sub-sequence and correct a corresponding on-screen candidate items.

The first cursor mode switch module 426 is adapted to switch from the current edition string cursor sliding mode to the candidate item cursor sliding mode.

The candidate cursor mode executing module 428 is adapted to enter the candidate item sliding mode; determine whether a sliding event received continuously in the candidate item cursor sliding mode meets a second switch condition; enter the candidate cursor moving module 430 if the sliding event received continuously does not meet the second switch condition; and enter the second cursor mode switch module 432 if the sliding event received continuously meets the second switch condition.

The candidate cursor moving module 430 is adapted to control a cursor to move in a candidate item based on the sliding event.

The second cursor mode switch module 432 is adapted to switch from the current candidate item cursor sliding mode to an edition string cursor sliding mode.

Preferably, the cursor determining module includes a cursor position determining module, a fist key determining module and a second key determining module.

The cursor position determining module is adapted to determine whether a first position of the cursor in a Pinyin string is in a Pinyin substring conforming to a Pinyin rule.

The first key determining module is adapted to select a corresponding key sub-sequence from a first Pinyin substring conforming to the Pinyin rule after the first position, as the key sub-sequence corresponding to the cursor, if the first position is not in the Pinyin substring conforming to the Pinyin rule.

The second key determining module is adapted to select a corresponding key sub-sequence from a Pinyin substring conforming to the Pinyin rule where the first position is located, as the key sub-sequence corresponding to the cursor, if the first position is in the Pinyin substring conforming to the Pinyin rule.

Preferably, the screening matching module includes a Pinyin string searching module, an initial candidate item acquiring module and a matching module.

The Pinyin string searching module is adapted to search for each Pinyin substrings corresponding to the key sub-sequence.

The initial candidate item acquiring module is adapted to acquire corresponding words and/or phrases from the each Pinyin substring, to obtain the initial candidate item.

The matching module is adapted to match the screening stroke sequence with a stroke sequence of each initial candidate item.

Preferably, the screening matching module includes a first screening matching module.

The first screening matching module is adapted to match the screening stroke sequence input by the user with the first stroke sequences formed by at least first strokes of each word of each of the initial candidate items.

Preferably, the first screening matching module may include an all stroke matching module and/or a first stroke matching module.

The whole stroke matching module is adapted to match the screening stroke sequence with the first stroke sequence formed by whole strokes of each word of each initial candidate item.

The first stroke matching module is adapted to match the screening stroke sequence with the first stroke sequence formed by first strokes of each word of each initial candidate item.

Preferably, in addition to the first screening matching module, the device further includes a first stroke sequence acquiring module.

The first stroke sequence acquiring module is adapted to acquire a first stroke sequence of each initial candidate item form a lexicon, for each initial candidate item.

Preferably, the first screening matching module further includes an error correction module.

The error correction module is adapted to, when the screening stroke sequence is not completely matched with the first stroke sequence of the initial candidate item, determine a probability that the stroke sequence input by the user is matched with the first stroke sequence of the initial candidate item by using the error correction model based on strokes; and determine that the screening stroke sequence is successfully matched with the first stroke sequence of the initial candidate item.

Preferably, the device further includes a first error correction model creating module and/or a second error correction model creating module.

The first error correction model creating module is adapted to create an error correction model based on strokes by using a binary or multiple relationship of words in a phrase and/or sentence.

The second error correction model creating module is adapted to create an error correction model based on strokes by using the binary and/or multiple relationship between strokes of each word.

Preferably, the screening sequence receiving module includes a separator receiving module.

The separator receiving module is adapted to determine whether there is a separator in the screening stroke sequence; and divided the screening stroke sequence input by the user into screening stroke sub-sequences based on the separator, if there is the separator.

Preferably, the first screening matching module includes a separation matching module.

The separation matching module is adapted to sequentially match, by taking the screening stroke sub-sequence as a unit, the screening stroke sub-sequence with a target stroke sub-sequence of a word at a corresponding position of each initial candidate item.

The algorithm and display provided here have no inherent relation with any specific computer, virtual system or other devices. Various general-purpose systems can be used together with the teaching based on this. According to the description above, the structure required to construct this kind of system is obvious. Besides, the disclosure is not directed at any specific programming language. It should be understood that various programming language can be used for achieving the content of the disclosure described here, and above description of specific language is for disclosing the optimum embodiment of the disclosure.

The description provided here explains plenty of details. However, it can be understood that the embodiments of the disclosure can be implemented without these specific details. The known methods, structure and technology are not shown in detail in some embodiments, so as not to obscure the understanding of the description.

Similarly, it should be understood that in order to simplify the disclosure and help to understand one or more of the various aspects of the disclosure, the various features of the disclosure are sometimes grouped into a single embodiment, drawing, or description thereof. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or process or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the present description (including the attached claims, abstract and figures) can be replaced by substitute feature providing the same, equivalent or similar purpose.

In addition, a person skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components of the device for leaving the message according to the embodiments in the disclosure in practice. The disclosure can also realize one part of or all devices or system programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

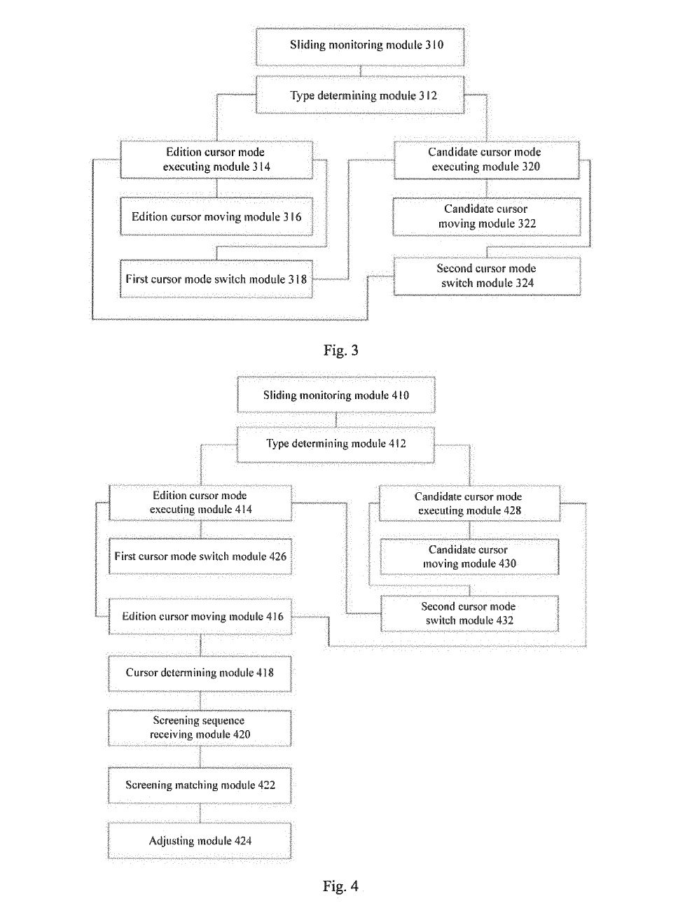

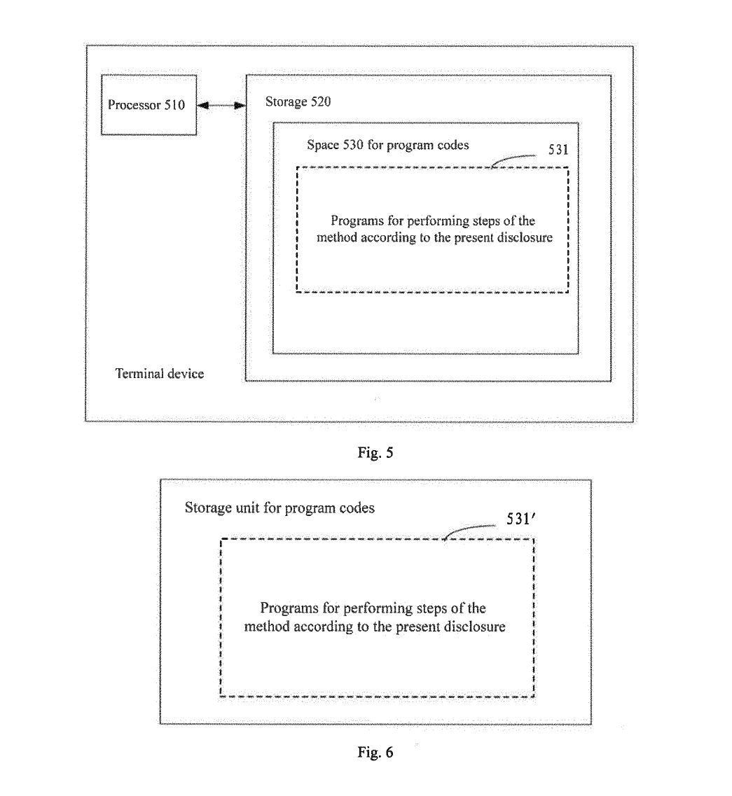

For example, FIG. 5 shows a terminal device for implementing the cursor operation method for an input method according to the disclosure The terminal device traditionally comprises a processor 510 and a computer program product in the form of storage 520 or a computer readable medium. The storage 520 can be electronic storage such as flash memory, EEPROM (Electrically Erasable Programmable Read—Only Memory), EPROM, hard disk or ROM, and the like. The storage 520 possesses storage space 530 for carrying out procedure code 531 of any steps of aforesaid method. For example, storage space 530 for procedure code can comprise various procedure codes 531 used for realizing any steps of aforesaid method. These procedure codes can be read out from one or more computer program products or write in one or more computer program products. The computer program products comprise procedure code carriers such as hard disk, Compact Disc (CD), memory card or floppy disk and the like. These computer program products usually are portable or fixed storage cell as said in FIG. 6. The storage cell can possess memory paragraph, storage space like the storage 520 in the computing device in FIG. 6. The procedure code can be compressed in, for example, a proper form. Generally, storage cell comprises computer readable code 531′, i.e. the code can be read by processors such as 510 and the like. When the codes run on a computer device, the computer device will carry out various steps of the method described above.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the systems can be embodied by a same hardware item. The use of words first, second and third does not mean any sequence. These words can be explained as name.

In addition, it should be noticed that the language used in the disclosure is chosen for the purpose of readability and teaching, instead of for explaining or limiting the topic of the disclosure. Therefore, it is obvious for a person skilled in the art to make a lot of modification and alteration without departing from the scope and spirit of the appended claims. For the scope of the disclosure, the disclosure is illustrative instead of restrictive. The scope of the disclosure is defined by the appended claims.

1-46. (cancel)

47. A cursor operation method for an input method, comprising:
monitoring whether a sliding event is received in a conventional word candidate mode of the input method;
determining a type of a preset mode condition which the sliding event meets, if the sliding event is received;
if the sliding event meets a first type of preset mode condition, entering an edition string cursor sliding mode and determining whether a sliding event continuously received in the edition string cursor sliding mode meets a first switch condition;
controlling the cursor to move in the edition string based on the continuously received sliding event if the continuously received sliding event does not meet the first switch condition; and
switching the current edition string cursor sliding mode to a candidate item cursor sliding mode if the continuously received sliding event meets the first switch condition;
if the sliding event meets a second type of preset mode condition, entering the candidate item cursor sliding mode and determining whether the sliding event continuously received in the candidate cursor sliding mode meets a second switch condition;
controlling the cursor to move in a candidate item based on the continuously received sliding event if the continuously received sliding event does not meet a second switch condition; and
switching the current candidate item cursor sliding mode to the edition string cursor sliding mode if the continuously received sliding event meets the second switch condition.

48. The method according to claim 1, wherein if the sliding event meets a first type of preset mode condition, entering an edition string cursor sliding mode and determining whether a sliding event continuously received in the edition string cursor sliding mode meets a first switch condition comprises:
changing a first state identification of a current conventional word candidate mode into a second state identification of the edition string cursor sliding mode, if the sliding event meets the first type of preset mode condition;
determining whether a current state identification of the input method is the second state identification, if a sliding event is continuously received; and
determining whether the sliding event continuously received in the edition string cursor sliding mode meets the first switch condition, if the current state identification of the input method is the second state identification.

49. The method according to claim 1, wherein if the sliding event meets a second type of preset mode condition, entering a candidate item cursor sliding mode and determining whether the sliding event continuously received in the candidate item cursor sliding mode meets a second switch condition comprises:
changing a first state identification of the current conventional word candidate mode into a third state identification of the candidate item cursor sliding mode, if the sliding event meets the second type of preset mode condition;
determining whether a current state identification of the input method is the third state identification, if a sliding event is continuously received; and
determining whether the continuously received sliding event in the candidate item cursor sliding mode meets the second switch condition, if the current state identification of the input method is the third state identification.

50. The method according to claim 1, wherein the determining a type of a preset mode condition which the sliding event meets comprises:
determining that the sliding event meets the first type of preset mode condition, if it is determined that the sliding event is a sliding operation towards a head of the edition string in a keyboard region of the input method; and
determining that the sliding event meets the second type of preset mode condition, if it is determined that the sliding event is a sliding operation towards an end of the candidate item in the keyboard region of the input method.

51. The method according to claim 1, wherein after the controlling the cursor to move in the edition string based on the sliding event, the method further comprises:
when the cursor is at an end of the edition string, exiting from the edition string cursor sliding mode if a character sequence input by a user is received again.

52. The method according to claim 1, wherein after the controlling the cursor to move in the edition string based on the continuously received sliding event, the method further comprises:
determining a key sub-sequence corresponding to the cursor;
receiving a screening stroke sequence input by a user;
matching the screening stroke sequence with a first stroke sequence of each of initial candidate items corresponding to the key sub-sequence; and
based on the matched initial candidate item, correcting and a Pinyin substring corresponding to the key sub-sequence and a subsequent key sub-sequence, and correcting a corresponding on-screen candidate items.

53. The method according to claim 1, wherein after the controlling the cursor to move in the candidate item based on the sliding event, the method further comprises:
exiting from the candidate item cursor sliding mode if a character sequence input by a user is received again.

54. The method according to claim 1, wherein the controlling the cursor to move in the candidate item based on the sliding event comprises:
when the cursor moves to a last candidate item displayed in a candidate bar, determining whether the last candidate item displayed in the candidate bar is an end candidate item if a sliding event towards an end of the candidate item is continuously received;
moving successively the candidate items displayed in the candidate bar towards a head if the last candidate item displayed in the candidate bar is not the end candidate item;
when the cursor moves to a first candidate item displayed in the candidate bar, determining whether a first candidate item displayed in the candidate bar is a head candidate item if a sliding event towards a head of the candidate item is continuously received; and
moving successively the candidate items displayed in the candidate bar towards the end if the first candidate item displayed in the candidate bar is not the head candidate item.

55. The method according to claim 1, wherein after the controlling the cursor to move in the candidate item based on the sliding event, the method further comprises:
correcting a corresponding edition string based on a candidate item at a position to which the cursor is moved.

56. A cursor operation device for an input method, comprising:
one or more processors; and
a memory;
wherein one or more programs are stored in the memory, and when executed by the one or more processors, the one or more programs cause the one or more processors to:
monitor whether a sliding event is received in a conventional word candidate mode of the input method;
determine a type of a preset mode condition which the sliding event meets, if the sliding event is received;
if the sliding event meets a first type of preset mode condition, enter an edition string cursor sliding mode and determine whether a sliding event continuously received in the edition string cursor sliding mode meets a first switch condition;
control the cursor to move in the edition string based on the continuously received sliding event if the continuously received sliding event does not meet the first switch condition; and
switch the current edition string cursor sliding mode to a candidate item cursor sliding mode if the continuously received sliding event meets the first switch condition;
if the sliding event meets a second type of preset mode condition, enter the candidate item cursor sliding mode and determine whether the sliding event continuously received in the candidate cursor sliding mode meets a second switch condition;
control the cursor to move in a candidate item based on the continuously received sliding event if the continuously received sliding event does not meet a second switch condition; and
switch the current candidate item cursor sliding mode to the edition string cursor sliding mode if the continuously received sliding event meets the second switch condition.

57. The device according to claim 10, wherein the one or more processors are further caused to:
change a first state identification of a current conventional word candidate mode into a second state identification of an edition cursor sliding mode, if the sliding event meets the first type of preset mode condition;
determine whether the current state identification of the input method is a second state identification, if a sliding event is continuously received; and
determine whether a sliding event received continuously in the edition string cursor sliding mode meets the first switch condition, if the current state identification of the input method is the second state identification.

58. The device according to claim 10, wherein the one or more processors are further caused to:
change a first state identification of the current conventional word candidate mode into a third state identification of a candidate item cursor sliding mode, if the sliding event meets a second type of preset mode condition;
determine whether a current state identification of the input method is a third state identification, if a sliding event is continuously received; and
determine whether a continuously received sliding event in the candidate item cursor sliding mode meets a second switch condition, if the current state identification of the input method is the third state identification.

59. The device according to claim 10, wherein the one or more processors are further caused to:
determine that the sliding event meets a first type of preset mode condition, if the sliding event is a sliding operation towards a head of the edition string in a keyboard region of the input method; and
determine that the sliding event meets a second type of preset mode condition, if the sliding event is a sliding operation towards an end of a candidate item in the keyboard region of the input method.

60. The device according to claim 10, wherein the one or more processors are further caused to:
when the cursor is at an end of the edition string, exit from the edition string cursor sliding mode if a character sequence input by a user is received again.

61. The device according to claim 10, wherein the one or more processors are further caused to:
determine a key sub-sequence corresponding to the cursor;
receive a screening stroke sequence input by a user;
match the screening stroke sequence with a first stroke sequence of each of initial candidate items corresponding to the key sub-sequence; and
based on the matched initial candidate items, correct a Pinyin substring corresponding to the key sub-sequence and a subsequent key sub-sequence and correct a corresponding on-screen candidate items.

62. The device according to claim 10, wherein the one or more processors are further caused to:
exit from the candidate item cursor sliding mode if a character sequence input by the user is received again.

63. The device according to claim 10, wherein the one or more processors are further caused to:
when the cursor moves to a last candidate item displayed in a candidate bar, determine whether a last candidate item displayed in the candidate bar is an end candidate item if a sliding event towards an end of the candidate item is continuously received; and move successively the candidate items displayed in the candidate bar towards a head, if the last candidate item displayed in the candidate bar is not the end candidate item; and
when the cursor moves to a first candidate item displayed in the candidate bar, determine whether a first candidate item displayed in the candidate bar is a head candidate item if a sliding event towards a head of the candidate item is continuously received; and move successively the candidate items displayed in the candidate bar towards the end, if the first candidate item displayed in the candidate bar is not the head candidate item.

64. The device according to claim 10, wherein the one or more processors are further caused to:
correct a corresponding edition string based on a candidate item at a position to which the cursor is moved.

65. A non-transitory computer readable medium having computer programs stored thereon that, when executed by one or more processors of a computing device, cause the computing device to perform operations for cursor operation method for an input method, the operations comprising:
monitoring whether a sliding event is received in a conventional word candidate mode of the input method;
determining a type of a preset mode condition which the sliding event meets, if the sliding event is received;
if the sliding event meets a first type of preset mode condition, entering an edition string cursor sliding mode and determining whether a sliding event continuously received in the edition string cursor sliding mode meets a first switch condition;
controlling the cursor to move in the edition string based on the continuously received sliding event if the continuously received sliding event does not meet the first switch condition; and
switching the current edition string cursor sliding mode to a candidate item cursor sliding mode if the continuously received sliding event meets the first switch condition;
if the sliding event meets a second type of preset mode condition, entering the candidate item cursor sliding mode and determining whether the sliding event continuously received in the candidate cursor sliding mode meets a second switch condition;
controlling the cursor to move in a candidate item based on the continuously received sliding event if the continuously received sliding event does not meet a second switch condition; and
switching the current candidate item cursor sliding mode to the edition string cursor sliding mode if the continuously received sliding event meets the second switch condition.
